(19) United States
(12) Patent Application Publication
(10) Pub. No.: US 2025/0110813 A1
(43) Pub. Date: Apr. 3, 2025

(54) DEVICE, METHOD AND SYSTEM FOR COMMUNICATING BETWEEN NETWORKED AGENTS VIA A CREDIT MANAGEMENT BUS

(71) Applicant: Intel Corporation, Santa Clara, CA (US)

(72) Inventors: Rahul Pal, Bangalore (IN); Ashish Gupta, San Jose, CA (US); William Bainbridge, Palo Alto, CA (US)

(73) Assignee: Intel Corporation, Santa Clara, CA (US)

(21) Appl. No.: 18/375,069

(22) Filed: Sep. 29, 2023

(51) Int. Cl. G06F 9/54

(52) U.S. Cl. CPC G06F 9/546; G06F 9/544

(57) ABSTRACT

Techniques and mechanisms for dynamically changing a distribution of credits with which initiator agents of a network access a shared target resource of the network. In various embodiments, a target agent and multiple initiator agents are coupled to each other via a switched network, and further via a credit management bus (CMB). The target agent manages a credit-based scheme according to which the initiator agents share access to a target resource. Communications via the CMB enable the target agent to determine, during a runtime of the network, whether a given initiator agent has been allocated an excessive number of credits, or an insufficient number of credits. In another embodiments, the target agent changes the distribution of credits to the initiator agents by allocating credits via the CMB.

### BACKGROUND

### 1. Technical Field

This disclosure generally relates to networked circuit resources and more particularly, but not exclusively, to credit-based management of access to network resources.

### 2. Background Art

The number of components on an integrated circuit (IC) chip is rapidly growing due to increasing levels of integration, system complexity and shrinking transistor geometry. Complex system-on-chips (SOCs) often include a variety of components e.g., processor cores, DSPs, hardware accelerators, memory and I/O, while chip multi-processors (CMPs) involve a large number of processor cores, memory and I/O subsystems. In both systems, on-chip interconnects play a role in providing high-performance communication between the various components. Due to scalability limitations of traditional buses and crossbar based interconnects, network-on-chip (NOC) has emerged as a paradigm to interconnect a large number of components on the chip. NOC uses a global shared communication infrastructure made up of several routing nodes which are interconnected with each other using point-to-point physical links.

In many applications, NOC and SOC technologies interconnect a target circuit resource (“target agent” or simply “target” herein) with multiple other circuit resources (“initiator agents” or or simply “initiators” herein) which are variously operable each to initiate a respective access of the target circuit resource. A common goal of these technologies is to enable non-blocking, congestion-free, and/or deadlock-free access to the target. However, achieving this goal is complicated by any of various factors, such as the different resource requirements of heterogeneous initiator agents.

As successive generations of IC chip technologies continue to scale with respect to their integration, variety, and capability, there is expected to be an increasing premium placed on improvements to the management of communications between networked resource of a given IC chip.

### BRIEF DESCRIPTION OF THE DRAWINGS

The various embodiments of the present invention are illustrated by way of example, and not by way of limitation, in the figures of the accompanying drawings and in which:

FIG. 1 shows a block diagram illustrating features of a system to manage an accessibility of networked resources according to an embodiment.

FIG. 2 shows a flow diagram illustrating features of a method to determine a distribution of credits among networked agents according to an embodiment.

FIG. 3 shows a block diagram illustrating features of a system to communicate messages that facilitate credit-based access management in a network according to an embodiment.

FIG. 4 shows a flow diagram illustrating features of a method to access networked resources based on a distribution of credits according to an embodiment.

FIG. 5 shows a block diagram illustrating features of a credit distribution unit to distribute credits for accessing networked resources according to an embodiment.

FIG. 6 shows a block diagram illustrating features of a credit monitor unit to request access to a networked resource based on a credit distribution according to an embodiment.

FIG. 7 shows a format diagram illustrating features of a message format to facilitate a management of access credits in a network according to an embodiment.

FIG. 8 illustrates an exemplary system.

FIG. 9 illustrates a block diagram of an example processor that may have more than one core and an integrated memory controller.

FIG. 10A is a block diagram illustrating both an exemplary in-order pipeline and an exemplary register renaming, out-of-order issue/execution pipeline according to examples.

FIG. 10B is a block diagram illustrating both an exemplary example of an in-order architecture core and an exemplary register renaming, out-of-order issue/execution architecture core to be included in a processor according to examples.

FIG. 11 illustrates examples of execution unit(s) circuitry.

FIG. 12 is a block diagram of a register architecture according to some examples.

### DETAILED DESCRIPTION

Embodiments discussed herein variously provide techniques and mechanisms for dynamically changing a distribution of credits with which initiator agents of a network are to variously access a shared target resource of the network. In various embodiments, a system (comprising a system-on-chip, for example) comprises at least one target agent and multiple initiator agents which are variously coupled—e.g., via a switched network—each to be able to access at least one or more shared resources of the target agent. The target agent manages a credit-based system according to which a given initiator agent is provided (or denied) access to a shared target resource. During a runtime of the system—e.g., during the communication of traffic via the switched network—credits are variously distributed among the multiple initiator agents to accommodate the respective resource demands of the initiators, while mitigating the risk that an access bandwidth for a target resource is exceeded. Some embodiments variously facilitate a dynamic redistribution of such credits among the multiple initiator agents during the runtime of the system. In one such embodiment, the target agent and the multiple initiator agents are further coupled to each other via another one or more interconnect structures which are referred to herein as a “credit management bus” (or “CMB”). Communications via such a credit management bus are performed during the runtime to facilitate a determination, by the target agent, as to whether—and if so, how—the system is to be transitioned from a current distribution of credits among the initiators to an alternative credit distribution.

Unless otherwise indicated, “credit distribution” (or, for brevity, simply “distribution”) refers herein to a distribution of credits among multiple initiator agents which are coupled to be able to share the same one or more resources of a target agent. For example, a given credit distribution comprises, for each initiator of the multiple initiators, a respective allocation of zero or more credits (and in some embodiments, each a respective allocation of one or more credits) to that initiator by the target agent. A given credit is “allocated” where, for example, said credit is currently available to be used by one—and, for example, only one—initiator for use in requesting access to a shared resource of a target (a “shared target resource” herein). By contrast, a credit is “unallocated” where it is not currently available to be used by any of the multiple initiators. For example, a target agent includes, is coupled to access, or otherwise operates based on a “credit pool”—i.e., a pool of one or more credits which are currently unallocated. In an embodiment, a target agent provides functionality to selectively draw credits from a credit pool for allocation, and/or to provide unallocated credits to the credit pool for possible future reallocation.

In various embodiments, communications via a credit management bus enable an initiator to be dynamically allocated—e.g., reallocated—credits during runtime. In one such embodiment, (re)allocation of credits is performed based on a condition (referred to herein as a “credit scarcity condition”) wherein a given initiator experiences one or more delays which are indicative of that initiator having resource needs which are not sufficiently accommodated by a current allocation of credits. For example, a credit scarcity condition is indicated where it is determined that a total delay, experienced by a given “credit-starved” initiator during some evaluation period, is greater than (or, in some embodiments, equal to) some threshold maximum delay value.

Alternatively or in addition, communications via a credit management bus enable an initiator to release credits for deallocation during runtime. In an embodiment, deallocation of credits is based on another condition (referred to herein as a “credit surplus condition”) wherein one or more credits allocated to a given “credit-rich” initiator remained unused for at least some threshold period of time.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including a hardware agent which supports a management of credit-based resource access with communications via a credit management bus.

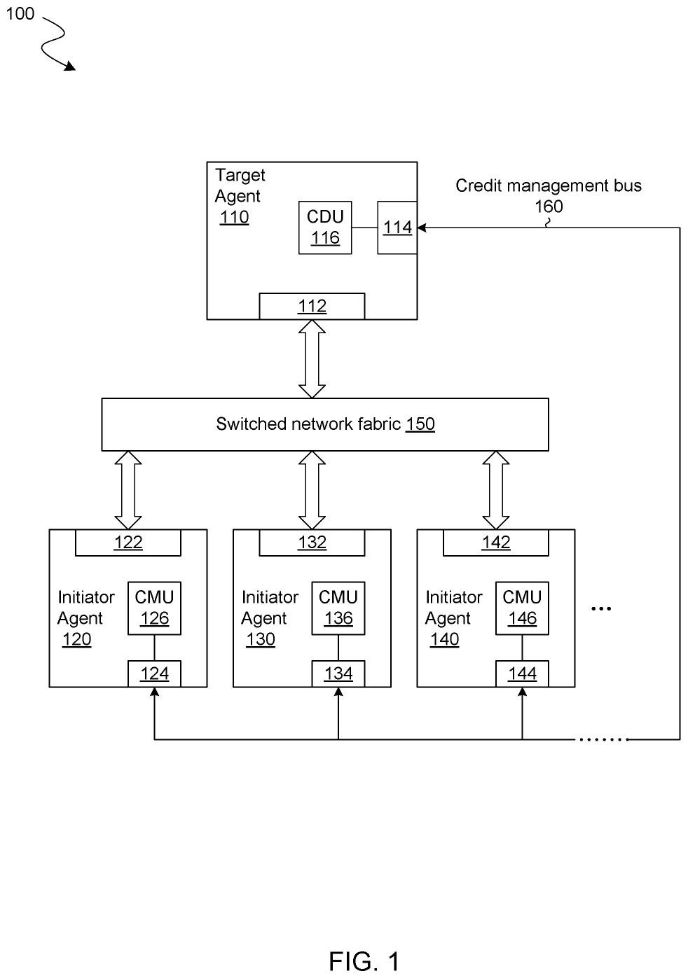

FIG. 1 shows a system 100 which manages an accessibility of networked resources according to an embodiment. System 100 illustrates one example embodiment wherein access to one circuit resource (a “target agent” herein) by other networked circuit resources (“initiator agents” or “source agents” herein) is provided on the basis of allocated credits. A dedicated interconnect structure (referred to herein as a “credit management bus”) facilitates communications by which such credits are variously distributed, requested, released, returned and/or the like.

As shown in FIG. 1, system 100 comprises a switched network fabric 150 and multiple hardware components (or “agents” herein) which are variously coupled to each other switched network fabric 150. In the implementation shown, these components include hardware agents which comprise at least one target agent 110 and multiple initiator agents (such as the illustrative initiator agents 120, 130, 140 shown) which variously provide functionality to access one or more resources of target agent 110 via switched network fabric 150. In some embodiments, system 100 is at least a portion of a system-on-chip or any of various other suitable semiconductor devices, such as a highly integrated processor complex or an integrated IO hub, and includes a switched network fabric 150 that acts as an interconnect between various components.

By way of illustration and not limitation, target agent 110 and some or all of initiator agents 120, 130, 140 variously provide respective functionalities such as compute capabilities, graphics capabilities, memory and/or storage capabilities, media processing capabilities and so forth. In one such embodiment, target agent 110 provides at least one functionality (e.g., a memory functionality, a compute functionality, or the like) which is available for any of initiator agents 120, 130, 140 to request or otherwise access via switched network fabric 150. Some embodiments are not limited to the particular one or more functionalities which a given target agent makes accessible to multiple initiator agents. Similarly, some embodiments are not limited to the particular one or more functionalities of a given initiator agent.

In the example embodiment shown, switched network fabric 150 is coupled to target agent 110 via a primary hardware interface 112 thereof, wherein switched network fabric 150 is further coupled to agents 120, 130, 140 via their respective primary hardware interfaces 122, 132, 142. Switched network fabric 150 comprises any of various combinations of routers, switches and/or other suitable devices (not shown) which are interconnected to facilitate communication between agents of system 100. For example, switched network fabric 150 comprises a ring topology, a mesh topology, a tree topology and/or any of various other suitable topologies. However, various embodiments are not limited with respect to a particular topology or topologies of switched network fabric 150.

In various embodiments, one or more routers of switched network fabric 150 are coupled to direct messages which initiator agents 120, 130, initiator agent 140 variously communicate via primary hardware interface 122, 132, 142 (respectively)—e.g., where target agent 110 is to receive such messages via primary hardware interface 112. In an embodiment, some or all such messages (e.g., including one or more read messages, write messages, control messages, compute message, or the like) are each to access a shared resource of target agent 110. For example, a given one of such messages requests access to a shared target resource, or otherwise uses said shared target resource to facilitate access of another resource of target agent 110. Unless otherwise indicated, “access message” refers herein to a message which an initiator agent communicates via a switched network to access a shared target resource.

In an embodiment, target agent 110 manages a credit-based scheme according to which initiator agents 120, 130, 140 are variously provided (or alternatively, denied) access to a shared target resource. During a runtime of system 100, credits are variously distributed among initiator agents 120, 130, 140 (and/or other initiator agents of system 100) to accommodate the respective resource demands of the initiators, while mitigating the risk of a shared target resource being overprovisioned. After the credits are distributed, and during the runtime of system 100, a given one such initiator agent avails of one of its currently-allocated credits to access the shared resource of target agent 110—e.g., by communicating via switched network fabric 150 an access message which includes, identifies or is otherwise associated with the allocated credit.

In an illustrative scenario according to one embodiment, initiator agent 120 communicates via switched network fabric 150 a first access message which identifies a first credit which is currently allocated to initiator agent 120. After receiving the first access message via primary hardware interface 112, target agent 110 determines, based on identified first credit, that initiator agent 120 has at least some right to access, for example, a shared message buffer (not shown) of target agent 110. Based on this determination, target agent 110 puts the first message in the shared message buffer for later processing by other circuitry of target agent 110—e.g., wherein target agent 110 returns the first credit to initiator agent 120 or, alternatively, sends the first credit to a pool of unallocated/deallocated credits.

Some embodiments variously facilitate a dynamic redistribution of such credits among initiator agents 120, 130, 140 during the runtime of system 100. For example, in one such embodiment, target agent 110 and initiator agents 120, 130, 140 are further coupled to each other via a credit management bus (CMB) 160. In the example embodiment shown, CMB 160 is coupled to target agent 110 via a secondary hardware interface 114 thereof—e.g., wherein CMB 160 is further coupled to agents 120, 130, 140 via their respective secondary hardware interfaces 124, 134, 144.

Communications via CMB 160 are performed during the runtime to facilitate a determination, by target agent 110, as to whether—and if so, how—system 100 is to be transitioned from a current distribution of credits among initiator agents 120, 130, 140 to an alternative distribution of credits among initiator agents 120, 130, 140. By way of illustration and not limitation, a credit distribution unit (CDU) 116 of target agent 110 participates in communications, via secondary hardware interface 114 and CMB 160, to send any of various credit management messages to some or all of initiator agents 120, 130, 140. CDU 116 comprises a microcontroller, processor core, application-specific integrated circuit (ASIC), and/or any of various other suitable circuit devices which are adapted to perform operations including (but not limited to) sending credit management messages, receiving messages which indicate initiator agent state, tracking a current distribution of credits, tracking a utilization of currently allocated credits, determining a next distribution of credits, and/or the like.

In the example embodiment shown, CDU 116 is coupled to communicate via CMB 160 with a credit monitor unit (CMU) 126 of initiator agent 120, a CMU 136 of initiator agent 130, and a CMU 146 of initiator agent 140. In one such embodiment, CMU 126 comprises circuitry—e.g., including a microcontroller, processor core, ASICs, and/or any of various other suitable circuit devices—which is adapted to perform operations including (but not limited to) receiving credit management messages, sending messages which indicate a state of initiator agent 120, tracking a current allocation of credits to initiator agent 120, monitoring a utilization of credits which are currently allocated to initiator agent 120, and/or the like. In one such embodiment, CMU 136 comprises circuitry to provide similar operations which facilitate credit management on behalf initiator agent 130—e.g., wherein CMU 146 comprises circuitry to provide similar operations which facilitate credit management on behalf initiator agent 140.

In one embodiment, CDU 116 provides functionality to send, via primary hardware interface 112 and CMB 160, a type of message (referred to as a “credit distribution message” herein) which allocates one or more credits to a given initiator agent. Alternatively or in addition, CDU 116 provides functionality to send, via primary hardware interface 112 and CMB 160, another type of message (referred to as a “credit release message” herein) which releases—i.e., identifies as being available again for reutilization—an already allocated one or more credits to a given initiator agent. In one such embodiment, a credit return message identifies to initiator agent 120 (for example) an availability of an already allocated credit which initiator agent 120 recently identified, provided, or otherwise used in the communication of an access message via the switched network fabric 150.

Although some embodiments are not limited in this regard, CDU 116 additionally or alternatively provides functionality to send, via primary hardware interface 112 and CMB 160, one or more configuration messages which (for example) set—e.g., reset—any of various thresholds and/or other parameters which facilitate credit distribution management. By way of illustration and not limitation, CDU 116 communicates a configuration message which sets one or more parameters with which CMU 126 (or one of CMUs 136, 146, for example) is to detect a credit scarcity condition. In one such embodiment, a configuration message (re)sets a threshold maximum delay for determining whether initiator agent 120 is in a credit scarcity condition. In an embodiment, the threshold maximum delay is a threshold maximum for an overall duration of any one or more delay events experienced—during a given evaluation period—each while initiator agent 120 waited for a credit to be available for an intended communication of a respective access message. In another embodiment, the threshold maximum delay is a threshold maximum total number of such delay events experienced during a given evaluation period. In some embodiments, a confirmation message additionally or alternatively sets a duration of the given evaluation period.

Alternatively or in addition, CDU 116 communicates via CMB 160 a configuration message which sets one or more parameters with which CMU 126 (or one of CMUs 136, 146, for example) is to detect a credit surplus condition. In one such embodiment, a configuration message (re)sets a threshold number of one or more credits which, during a given evaluation period, remain unused by initiator agent 120 for the communication of any access message. For example, initiator agent 120 is in a credit surplus condition where it is determined by CMU 126 that a total number of unused—or “idle”—credits for the given evaluation period is greater than (in some embodiments, greater than or equal to) the threshold number. In some embodiments, a confirmation message additionally or alternatively sets a duration of the given evaluation period.

In various embodiments, CDU 116 provides functionality to receive, via CMB 160, a type of message (referred to herein as a credit request message) with which the CMU of a given initiator agent requests that CDU 116 allocate one or more additional credits to said initiator agent. In one such embodiment, a credit request message specifies or otherwise indicates a credit scarcity condition to CDU 116—e.g., wherein the credit request message identifies a total number of credits being requested and/or indicates one or more characteristics of the credit scarcity condition (such as a total duration of one or more delay events during a given evaluation period, a total number of delay events, or the like).

In various embodiments, CDU 116 additionally or alternatively provides functionality to receive, via CMB 160, a type of message (referred to herein as a credit release message) with which the CMU of a given initiator agent releases one or more credits for deallocation, and possible reallocation. In one such embodiment, a credit release message specifies or otherwise indicates a credit surplus condition to CDU 116—e.g., wherein the credit release message identifies a total number of credits being released for deallocation.

Accordingly, some provide and/or otherwise facilitate management of a dynamic credit distribution with a target agent, which is operable to vary a distribution of credits among two or more initiator agents. In one such embodiment, credit redistribution is performed during system runtime based on a current credit redistribution, the resource demands of one or more initiator agents, and/or a number of unallocated credits (if any) which are currently in a credit pool. In some embodiments, CDU 116 (for example) selectively enables a restoration of system 100 a relatively fair credit distribution—e.g., from a less fair distribution of credits among initiator agents 120, 130, 140. Some embodiments thus facilitate non-blocking and/or low congestion operation of a system on chip, network on chip, or the like—e.g., while promoting an efficient sharing of target resource bandwidth across multiple initiator agents.

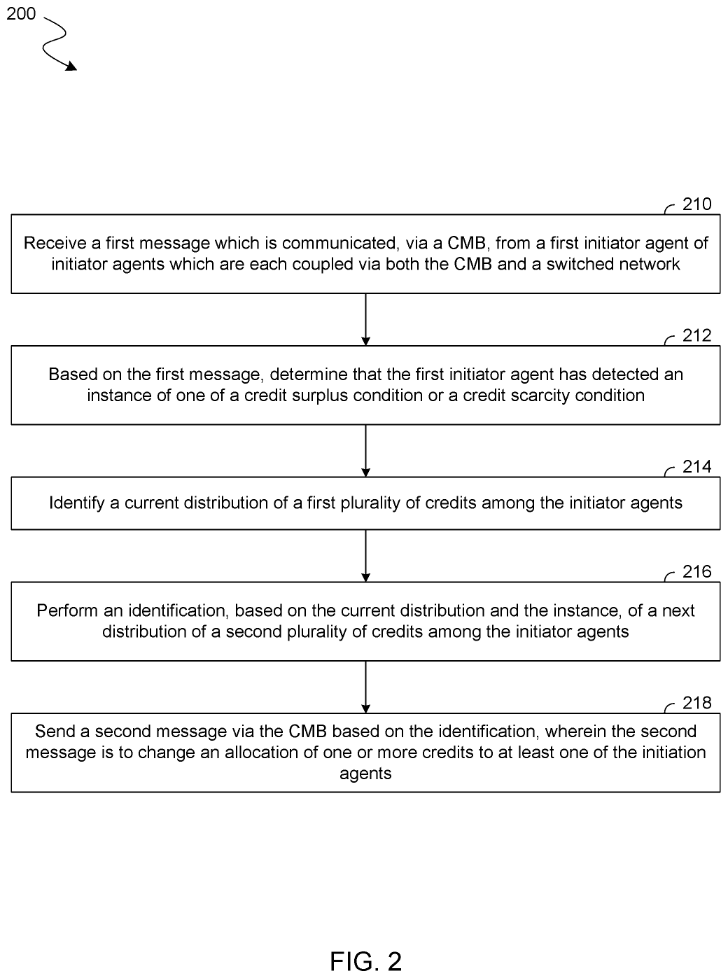

FIG. 2 shows a method 200 for determining a distribution of credits among networked agents according to an embodiment. Method 200 illustrates one example of an embodiment wherein a credit distribution is implemented with, and/or is otherwise based on, communications via a credit distribution bus which is distinct from a switched network by which initiator agents variously access a shared resource of a target agent. Operations such as those of method 200 are performed with any of various combinations of suitable hardware (e.g., circuitry) and/or executing software which, for example, provide some or all of the functionality of system 100.

As shown in FIG. 2, method 200 comprises (at 210) receiving at a target agent a first message which is communicated, via a credit management bus (CMB), from a first initiator agent. In an embodiment, the first initiator agent is one of multiple initiator agents which are each coupled to the target agent via both the CMB and a switched network.

Based on the first message, method 200 (at 212) determines, with the target agent, that the first initiator agent has detected a first instance of one of a credit surplus condition or a credit scarcity condition. In one such embodiment, the first message is a credit request message which specifies or otherwise indicates that, during some evaluation period, the first initiator agent experienced one or more delays each while waiting for an availability of a respective credit. A total duration of the one or more delays (and/or a total number of the one or more delays, for example) exceeded some threshold delay parameter. For example, the credit request message identifies a number of credits being requested for allocation to the first initiator agent.

In another such embodiment, the first message is a credit release message which specifies or otherwise indicates that one or more credits, which were allocated to the first initiator agent, remained idle (i.e., unused for any access request) during some evaluation period. For example, the credit release message identifies a number of credits being released by the first initiator agent for deallocation (or being requested for deallocation).

Method 200 further comprises (at 214) identifying, at the target agent, a current distribution of a first plurality of credits among the multiple initiator agents. During the current distribution, the distributed credits are variously allocated each to a respective one (for example, only one) of the multiple initiator agents—e.g., wherein an allocated credit is available to be used by a respective initiator agent in the communication of a request message which accesses a shared resource of the target agent. For example, the shared resource is a buffer of the target agent, wherein access requests of the initiator agents are variously communicated via the switched network, and kept in the buffer for subsequent processing by the target agent. Additionally or alternatively, the shared resource comprises target circuitry which variously performs such processing of such access requests.

Based on the current distribution and the first instance, method 200 (at 216) performs an identification of a next distribution of a second plurality of credits among the multiple initiator agents. In an embodiment, identifying the next distribution at 216 comprises determining that a credit, indicated by a credit release message from one of the multiple initiator agents, is available to mitigate a credit scarcity condition indicated by a credit demand message from one of the multiple initiator agents, wherein the credit release message and the credit demand message are each received by the target agent via the CMB. Additionally or alternatively, identifying the next distribution at 216 comprises determining whether one or more unallocated credit (if any)—e.g., in a pool of currently unallocated credits—are available to be drawn from the pool and allocated to mitigate a credit scarcity condition of one of the multiple initiator agents.

In various embodiments, identifying the next distribution at 216 comprises determining whether a baseline distribution of credits among the initiator agents would resolve any currently pending credit deficit conditions. Additionally or alternatively, identifying the next distribution at 216 comprises determining whether such a baseline distribution of credits would resolve one or more currently pending credit surplus conditions. In one such embodiment, the baseline distribution of credits comprises a total number of one or more allocated credits being the same for each of the multiple initiator agents.

Based on the identification performed at 216, method 200 (at 218) sends a second message via the CMB, wherein the second message is to change an allocation of one or more credits to at least one of the initiation agents. The second message sent at 218 is at least one communication to implement a transition from the current distribution of the first plurality of credits to the next distribution of the second plurality of credits. For example, implementing the transition from the current distribution to the next distribution comprises changing a credit from being allocated to one initiator agent (which communicated a credit release message via the CMB), to being allocated to another initiator agent (which communicated a credit demand message via the CMB). In some embodiments, multiple communications are sent by the target agent via the CMB to implement the transition—e.g., wherein the multiple communications include one or more credit distribution messages each to a different respective initiator agent and/or one or more credit deallocation messages each to a different respective initiator agent.

After the next credit distribution has become the new current credit distribution, the multiple initiator agents, each using a different respective one or more of the second plurality of credits, are variously able to access the same shared resource of the target agent via the switched network. In some embodiments, the second plurality of credits is the same as the first plurality of credits—e.g., wherein only the distribution of said credits among the initiator agents is different. In other embodiments, a total number of the first plurality of credits is different than a total number of the second plurality of credits—e.g., wherein a number of credits in the credit pool changes between the current credit distribution and the next credit distribution.

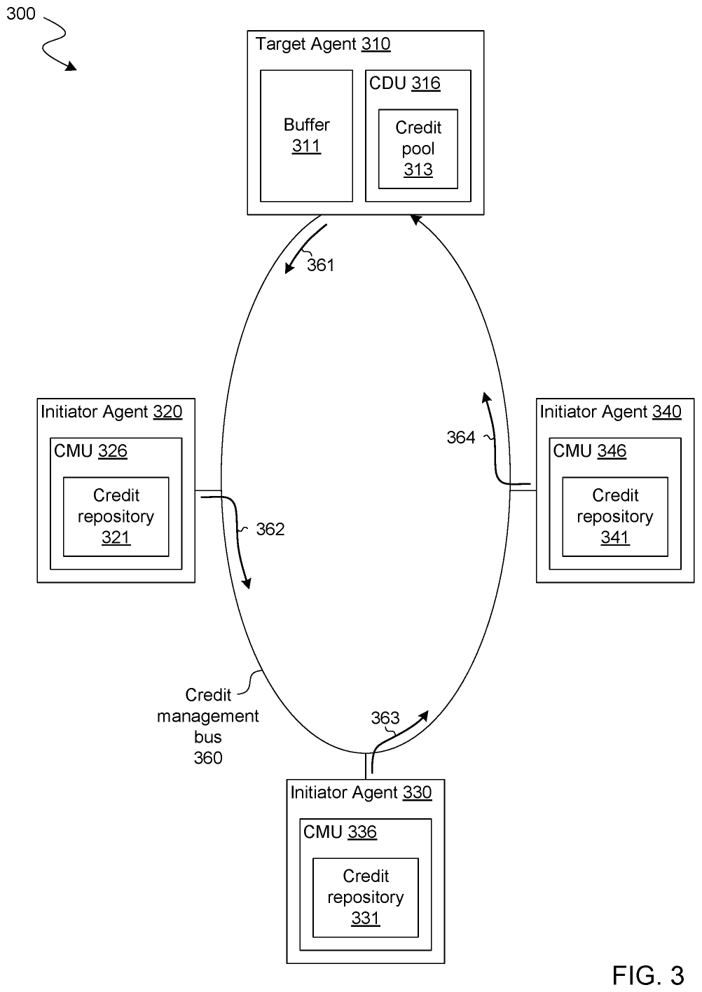

FIG. 3 shows a system 300 which communicates messages that facilitate management of credit-based access in a network according to an embodiment. System 300 illustrates one example embodiment wherein agents are coupled to each other, in a ring topology, via a CMB which facilitates dynamic credit redistribution. In some embodiments, system 300 provides functionality such as that of system 100—e.g., wherein operations of method 200 are performed with structures of system 300.

As shown in FIG. 3, system 300 comprises a CMB 360, a target agent 310, and multiple initiator agents—such as the illustrative initiator agents 320, 330, 340 shown—which are variously coupled to target agent 310 via a CMB 360. In various embodiments, target agent 310 and initiator agents 320, 330, 340 are further coupled to each other via a switched network (not shown) by which initiator agents 320, 330, 340 variously communicate requests to access a shared resource of target agent 310. In one such embodiment, target agent 310 and CMB 360 correspond functionally to target agent 110 and CMB 160 (respectively)—e.g., wherein initiator agents 320, 330, 340 provide functionality such as that of initiator agents 120, 130, 140.

Target agent 310 comprises a CDU 316 which, for example, provides functionality of CDU 116. In an embodiment, CDU 116 includes, is coupled to access, or otherwise operates with one or more resources of target agent 310 which are shared by initiator agents 320, 330. 340. In the example embodiment shown, one such shared target resource is a buffer 311 that is to receive access requests which initiator agents 320, 330, 340 variously communicate via the switched network. In one such embodiment, CDU 316 comprises circuitry which manages the distribution—e.g., including dynamic redistribution—of credits with which accessibility of buffer 311 is determined.

At a given time during operation of system 300, some or all such credits are variously allocated to multiple agents including initiator agents 320, 330, 340. For example, a CMU 326 of initiator agent 320 includes or is coupled to access a credit repository 321 which is to receive and provide information that specifies or otherwise indicates a total number of credits which are currently allocated to initiator agent 320. By way of illustration and not limitation, credit repository 321 includes any of various registers and/or other circuity which is suitable to store allocated credits, or information which otherwise facilitates the identification of a given allocated credit when initiator agent 320 sends an access request. Similarly, a CMU 336 of initiator agent 330 includes a credit repository 331 to track credits which are currently allocated to initiator agent 330—e.g., wherein another CMU 346 of initiator agent 340 includes a credit repository 341 to track credits which are currently allocated to initiator agent 340. In one such embodiment, CMUs 326, 336, 346 correspond functionally to CMUs 126, 136, 146 (respectively).

CMB 360 supports communications to facilitate a redistribution of credits among some or all initiator agents during a runtime of system 300. In an illustrative scenario according to one embodiment, communications via CMB 360 comprise one or more messages (such as the illustrative message 361) from target agent 310, and further comprise respective messages 362, 363. 364 from CMUs 321, 331, 341.

In one such embodiment, a given message from target agent 310 (such as message 361) is addressed to a particular one of initiator agents 320, 330, 340. By way of illustration and not limitation, message 361 is a credit distribution message which allocates one or more credits to a particular initiator agent. In another embodiment, message 361 is a credit return message which returns a currently allocated credit for reuse by a particular initiator agent—e.g., after that credit was used for an access request by that particular initiator agent. In other embodiments, a credit return message is instead communicated from target agent 310 to an initiator agent via the switched network. In some embodiments, message 361 (or another message sent from target agent 310 via CMB 360) is a configuration message which (re) sets any of various thresholds and/or other parameters which facilitate credit distribution management.

In some embodiments, a given one of messages 362, 363, 364 is a credit release message with which the corresponding one of CMUs 321, 331, 341 releases to CDU 316 one or more credits for deallocation. For example, such released credits are sent to a credit pool 313 of CDU 316, where unallocated credits are available for possible later redistribution among initiator agents 320, 330, 340. Alternatively or in addition, a given one of messages 362, 363, 364 is a credit request message with which the corresponding one of CMUs 321, 331, 341 asks that CDU 316 allocate one or more additional credits. For example, CDU 316 allocates some or all such one or more additional credits from credit pool 313 or (for example) from one or more other initiator agents which each currently experience a respective credit surplus condition.

Based on such communications via CMB 360, CDU 316 operates in combination with CMUs 321, 331, 341 to implement a distribution of credits among initiator agents 320, 330, 340, and to monitor the respective utilizations of credits by initiator agents 320, 330, 340. Furthermore, such communications via CMB 360 enable CDU 316 to detect, for each of initiator agents 320, 330, 340, whether the initiator agent in question is currently experiencing a credit surplus condition or a credit scarcity condition.

Based on such detecting, CDU 316 is operable to identify a next credit distribution to be implemented as a substitute for the current credit distribution—e.g., wherein CDU 316 variously communicates one or more credit allocations via CMB 360 to provide the next credit distribution. In some embodiments, CDU 316 dynamically performs multiple successive rounds of credit redistributions, using CMB 360, as the various resource needs of initiator agents 320, 330, 340 change during runtime operation of system 300. In one such embodiment, an initiator agent which sends a credit release message via CMB 360, or which otherwise indicates a credit surplus condition to CDU 316, is precluded from receiving any additional credit(s) in a next round of credit redistribution.

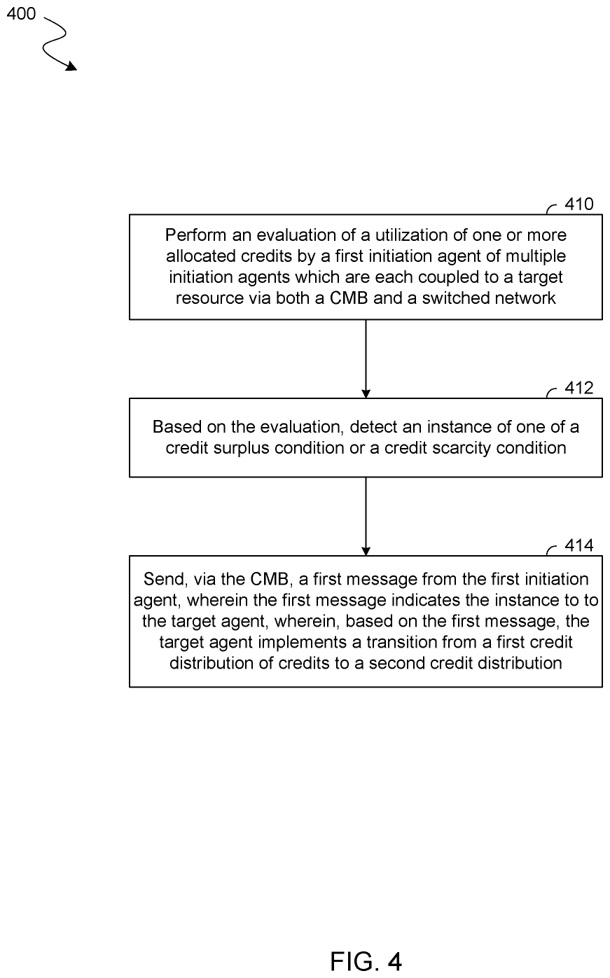

FIG. 4 shows a method 400 for accessing networked resources based on a distribution of credits according to an embodiment. Method 400 illustrates one example of an embodiment wherein an initiator agent performs operations to provide credit utilization information which is to be a basis for redistributing credits among multiple initiator agents. Operations such as those of method 400 are performed with any of various combinations of suitable hardware (e.g., circuitry) and/or executing software which, for example, provide some or all of the functionality of one of initiator agents 120, 130, 140, or of one of initiator agents 320, 330, 340. In some embodiments, method 400 includes or is otherwise performed in combination with some or all operations of method 200.

As shown in FIG. 4, method 400 comprises (at 410) performing an evaluation of a utilization of one or more allocated credits by a first initiation agent of multiple initiation agents which are each coupled to a target resource via both a CMB and a switched network. For example, the evaluation performed at 410 comprises determining a duration and/or number of one or more delays (if any) which were experienced during a given test period, where each such delay was due at least in part to the first initiator agent waiting for an availability of a credit for communicating a respective access request via the switched network. Alternatively or in addition, the evaluation performed at 410 comprises determining whether, throughout a given test period, the first initiator agent had one or more allocated credits which were idle.

Based on the evaluation performed at 410, method 400 (at 412) detects an instance of one of a credit surplus condition or a credit scarcity condition. By way of illustration and not limitation, the detecting at 412 comprises the first initiator agent determining that a total duration and/or a total number of one or more delays was above some predetermined threshold delay amount. Alternatively or in addition, the detecting at 412 comprises the first initiator agent determining that, throughout a given test period, a total number of idle credits allocated to the first initiator agent was never less than some predetermined threshold number.

Method 400 further comprises (at 414) sending, via the CMB, a first message from the first initiation agent, wherein the first message indicates the instance to the target agent. For example, the sending at 414 comprises the first initiator agent generating one of a credit demand message or a credit release message. Based on the first message, the target agent sends one or more messages—via the CMB—to implement a transition from a first distribution of credits among the multiple initiation agents, to a second distribution of credits among the multiple initiation agents.

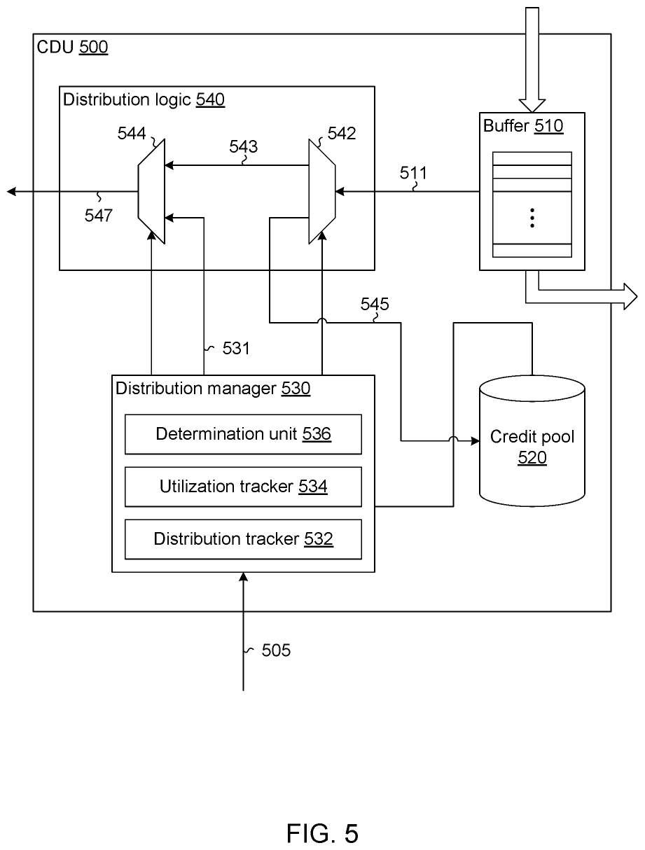

FIG. 5 shows a credit distribution unit (CDU) 500 which manages the redistribution of credits for accessing a network resource according to an embodiment. CDU 500 illustrates one example of an embodiment which facilitates operations, and communications via a credit management bus, to manage a credit scheme according to which multiple initiator agents access a shared resource of a target agent. In some embodiments, CDU 500 provides functionality such as that of CDU 116 or CDU 316—e.g., wherein operations of method 200 are performed with CDU 500.

As shown in FIG. 5, CDU 500 comprises a distribution manager 530 and distribution logic 540 which is coupled to operate with distribution manager 530 to variously distribute credits among initiator agents which share access to a target resource. In the example embodiment shown, the shared target resource is a buffer 510 which is a component of CDU 500. However, in an alternative embodiment, is another component (which is external of, and coupled to, CDU 500) of a target agent which also includes CDU 500. Buffer 510 comprises entries to receive access requests which multiple initiator agents (e.g., including initiator agents 120, 130, 140) variously provide, via a switched network, to a target agent which comprises CDU 500. In one embodiment, all entries of buffer 510 are shared by the multiple initiator agents—e.g., wherein each such entry is subject to receiving an access request from any of the multiple initiator agents.

In some other embodiments, buffer 510 comprises two or more partitions, including one partition which is shared by the multiple initiator agents, and another partition which (for example) is at least temporarily restricted from access by some or all of the multiple initiator agents. By way of illustration and not limitation, the one or more other partitions of buffer 510 each correspond to a different respective virtual channel which, for example, corresponds to a particular type (or types) of communication. In one such embodiment, a virtual channel is at least temporarily allocated to a particular initiator agent at a given time—e.g., for that particular initiator agent to have exclusive access to a corresponding partition of buffer 510. In various embodiments, such exclusive access is managed via a CMB, which is distinct from the switched network by which the initiator agents variously access buffer 510. For example, CDU 500 additional or alternatively allocates—via the CMB—credits to access a given virtual channel (and thus, a corresponding partition of buffer 510). In one such embodiment, an initiator agent releases such credits, via the CMB, to surrender control of the virtual channel.

In an embodiment, distribution manager 530 comprises a microcontroller, processor core, application-specific integrated circuit (ASIC), and/or any of various other suitable types of circuitry which is adapted to determine (and implement) a next distribution of credits among multiple initiator agents. In the example embodiment shown, distribution manager 530 comprises a distribution tracker 532, a utilization tracker 534, and a determination unit 536. Distribution tracker 532 comprises circuitry to track a current distribution of credits among multiple initiator agents. For example, distribution tracker 532 comprises one or more registers, counters and/or other suitable circuitry to provide, update and/or otherwise facilitate a registry which indicates, for each initiator agent of multiple initiator agents that share buffer 510, a total number of the one or more credits (if any) which are currently allocated to that initiator agent. In an embodiment, distribution tracker 532 is further operable to track a number of one or more credits which are currently unallocated. For example, CDU 500 includes, is coupled to, or otherwise operates with a credit pool 520 (e.g., comprising a counter, one or more registers and/or the like) that facilitates a tracking of currently unallocated credits. For example, a given unallocated credit in credit pool 520 has yet to be allocated to any initiator agent, or was previously released to CDU 500 by an initiator agent for deallocation.

In one such embodiment, utilization tracker 534 comprises circuitry to determine, based on messages which CDU 500 receives via a CMB, how the initiator agents are variously utilizing respective allocated credits. For example, utilization tracker 534 is operable to receive, snoop or otherwise detect any of various messages (such as the illustrative message 505 shown) which an initiator agent communicates to CDU 500 via a CMB. By way of illustration and not limitation, message 505 is a credit release message which indicate that a given initiator agent is currently experiencing a credit surplus condition. Alternatively, message 505 is a credit demand message which indicates that the initiator agent is instead currently experiencing a credit scarcity condition. Based on such received messages, utilization tracker 534 performs one or more evaluations to determine, for each of the multiple initiator agents, an amount of credit surplus or credit deficit which the initiator agent is experiencing.

In one such embodiment, utilization tracker 534 comprises circuitry to determine—based on the registry provided with distribution tracker 532, and further based on the various credit surpluses and/or credit deficits (if any) detected by utilization tracker 534—a next distribution of credits to be variously allocated among the multiple initiator agents. By way of illustration and not limitation, determining a next credit distribution comprises utilization tracker 534 identifying one or more surplus credits, each from respective credit-rich agent, as being candidates for reallocation to any of one or more credit-starved agents.

In some embodiments, determining a next credit distribution comprises utilization tracker 534 evaluating whether a predetermined baseline credit distribution will satisfy the current resource demands of the initiator agents. In one such embodiment, the baseline credit distribution is a relatively fair distribution—e.g., wherein each of the initiator agents is allocated an equal number of credits. In another embodiment, the baseline credit distribution is a weighted distribution—e.g., wherein initiator agents are each allocated a respective one or more credits according to a type of that initiator agent. For example, the initiator agents include agents of multiple different types—e.g., including one or more processor types, processor core types, controller types, and/or the like—where each such type is predetermined to correspond to respective number of credits according to an expected resource demand by that initiator type. In various embodiments, determination unit 536 provides functionality to identify the respective types of the various initiator agents, and to selectively allocate or deallocate credits, as needed, to implement a next credit distribution (such as a baseline credit distribution, in some embodiments).

In an embodiment, distribution manager 530 signals distribution logic 540 to variously allocate one or more credits, and/or deallocate one or more credits, to implement the next credit distribution. In the example embodiment shown, distribution logic 540 comprises a demultiplexer (DMUX) 542 which is coupled to receive credits—such as the illustrative credit 511 shown—which, in some embodiments, are provided to buffer 510 (or are otherwise communicated to the target agent) in access requests received via the switched network. DMUX 542 is controlled by distribution manager 530 to selectively direct credit 511 (or any of various other such allocated credits) for communication to credit pool 520 as a deallocated credit 545, or for communication as an allocated credit 543 to a multiplexer (MUX) 544 of distribution logic 540. For example, in some embodiments, an initiator agent releases credits to a target agent via a CMB for deallocation—e.g., wherein message 505 is a credit release message which includes one or more credits to be deallocated and provided to credit pool 520.

In an alternative embodiment, such a credit release message merely specifies or otherwise indicates a number of credits which the initiator agent in question is able to have deallocated. Based on such a credit release message, distribution manager 530 operates DMUX 542 to prevent a return of one or more credits to the initiator agent which sent the credit release message. For example, DMUX 542 is operated instead to send the deallocated one or more credits (which, for example, are each received by the target agent in a respective access message via the switched network) to the credit pool 520.

In an embodiment, MUX 544 is controlled by distribution manager 530 to select between credit 543 and another credit 531 which (for example) distribution manager 530 retrieved from credit pool 520 or, alternatively, received via the CMB in message 505 (e.g., a credit release message). In an embodiment, the selected one of credit 543 or credit 531 is output as an allocated credit 547 which is to be communicated, via the CMB, to one of the initiator agents. In one such embodiment, credit 547 is sent back to the same initiator agent to which credit 547 is already allocated. Alternatively, credit 547 is communicated via the CMB for a new allocation to a different initiator agent.

In an illustrative scenario according to one embodiment, determination unit 536 determines that credit pool 520 has an insufficient number of unallocated credits to satisfy a credit demand of a credit-starved initiator agent. Based on such a determination, determination unit 536 implements a credit redistribution—e.g., wherein determination unit 536 provides to credit pool 520 one or more credits each from a respective credit-rich initiator agent. Credits in credit pool 520 are then reallocated to one or more credit-starved initiator agents—e.g., according to the respective credit demands indicated by those agents in communications via the CMB. In one such embodiment, an initiator agent that received and released one or more surplus credits from one credit redistribution (e.g., a most recent redistribution), is not a candidate to receive back credits in a next redistribution. Instead, some or all of the released surplus credits are variously kept in credit pool 520, or reallocated to one or more different initiator agents, for example. This mitigates the possibility of one or more initiator agents perpetually benefiting at the cost of one or more other initiator agents—e.g., to promote a return to a fairness of credit access by the initiator agents.

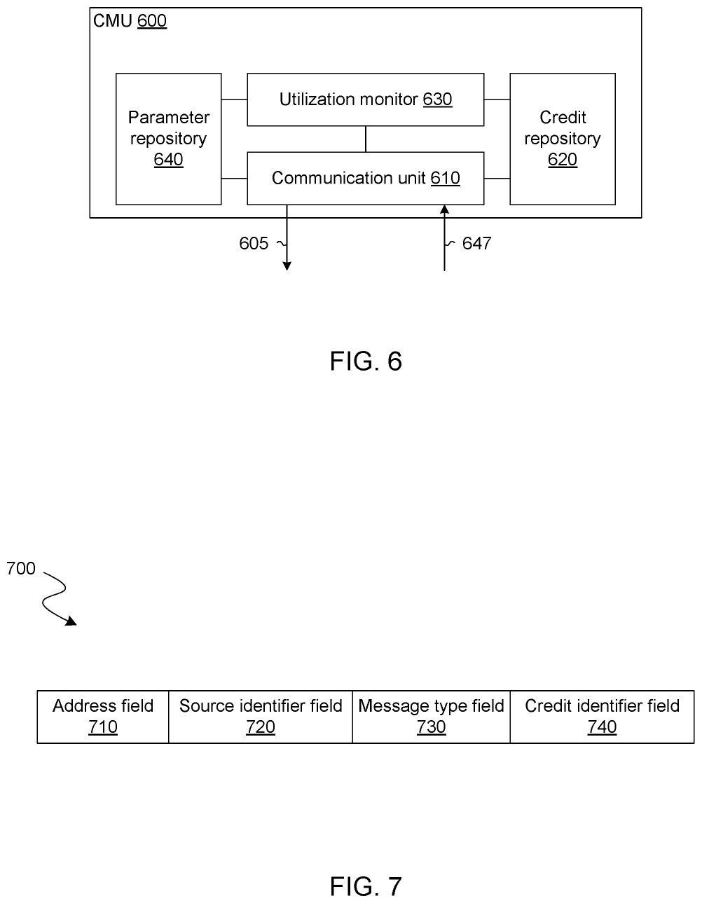

FIG. 6 shows a CMU 600 which requests access to a networked resource based on a credit distribution according to an embodiment. CMU 600 illustrates one example embodiment which enables an initiator agent to communicate credit utilization and/or credit allocation information with a target agent via a CMB. In some embodiments, CMU 600 provides functionality such as that of one of CMUs 126, 136, 146, 326, 336, 346—e.g., wherein operations of method 400 is performed with circuitry of CMU 600.

As shown in FIG. 6, CMU 600 comprises a communication unit 610 to send one or more messages (such as the illustrative message 605 shown) to a target agent via a CMB, and/or to receive one or more other messages (such as the illustrative message 647 shown) from the target agent via the CMB. For example, message 605 is any of various credit request messages or any of various credit release messages. Alternatively or in addition, message 647 is any of various credit distribution messages, any of various credit deallocation messages, any of various configuration messages, or the like.

In some embodiments, CMU 600 further comprises a credit repository 620 which is coupled to receive one or more credits which are allocated, by a target agent, to an initiator agent which includes CMU 600. For example, the one or more credits are received at CMU 600 by one or more messages that are communicated to communication unit 610 via the CMB.

In various embodiments, CMU 600 further comprises a utilization monitor 630 which is configured to evaluate a utilization of the one or more allocated credits which are currently kept in credit repository 620. For example, utilization monitor 630 is operable to determine whether (or not) a number of idle credits in credit repository 620 remains above some threshold number throughout a given test period. Alternatively or in addition, utilization monitor 630 is operable to determine whether (or not) the initiator agent which comprises CMU 600 experienced more than some threshold duration and/or number of one or more delays (if any) during a given test period. In some embodiments, a parameter repository 640 or CMU 600 includes information which specifies or otherwise indicates one or more evaluation parameters, such as a threshold number of delays, a threshold duration of one or more delays, a threshold number of idle credits, or the like.

In various embodiments, some or all parameter values in parameter repository 640 are subject to being initialized, reset or otherwise determined based on one or more configuration messages which CMU 600 receives from the target agent (or any of various suitable network resources)—e.g., where the one or more configuration messages are communicated via the CMB or, alternatively, via a switched network which couples the target agent to multiple initiator agents.

FIG. 7 shows a format 700 of a message which is to facilitate a management of access credits in a network according to an embodiment. Message format 700 demonstrates one example of a message which is communicated via a CMB to provide credit utilization information, credit allocation information (such as credit deallocation information), or the like. Information such as that which is provided according to message format 700 is communicated, for example, with target agent 110 or with one of initiator agents 120, 130, 140—e.g., wherein operations of one of methods 200, 400 are based on (for example, include), or result in, a communication of such information.

As shown in FIG. 7, a message having format 700 comprises an address field 710 which is to provide an identifier of a particular agent (e.g., a specific initiator agent or, alternatively, a specific target agent) which is to receive said message. Furthermore, a message having format 700 comprises a source identifier field 720 which is to provide an identifier of the agent from which the message was sent. Further still, a message having format 700 comprises a message type field 730 which is to identify a type of said message. For example, message type field 730 identifies a particular one of multiple message types which, in some embodiments, include (but are not limited to) a credit release message type, a credit demand message type, a credit distribution message type, a configuration message type, or the like.

In one such embodiment, a message having format 700 further comprises a credit identifier field 740 which is to specify or otherwise indicate one or more credits to which the message pertains. By way of illustration and not limitation, credit identifier field 740 identifies a total number of one or more credits which are being allocated, returned, deallocated, released, or the like. In one such embodiment, credit identifier field 740 includes one or more unique identifiers each for a different respective credit to which the message in question pertains.

The particular order, and the respective sizes of fields 710, 720, 730, 740 is merely illustrative, and not limiting on some embodiments. In some embodiments, message format 700 further comprises any of various other fields (not shown) to facilitate the communication and/or use of information which enables a dynamic redistribution of credits using a credit management bus.

### Exemplary Computer Architectures

Detailed below are describes of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

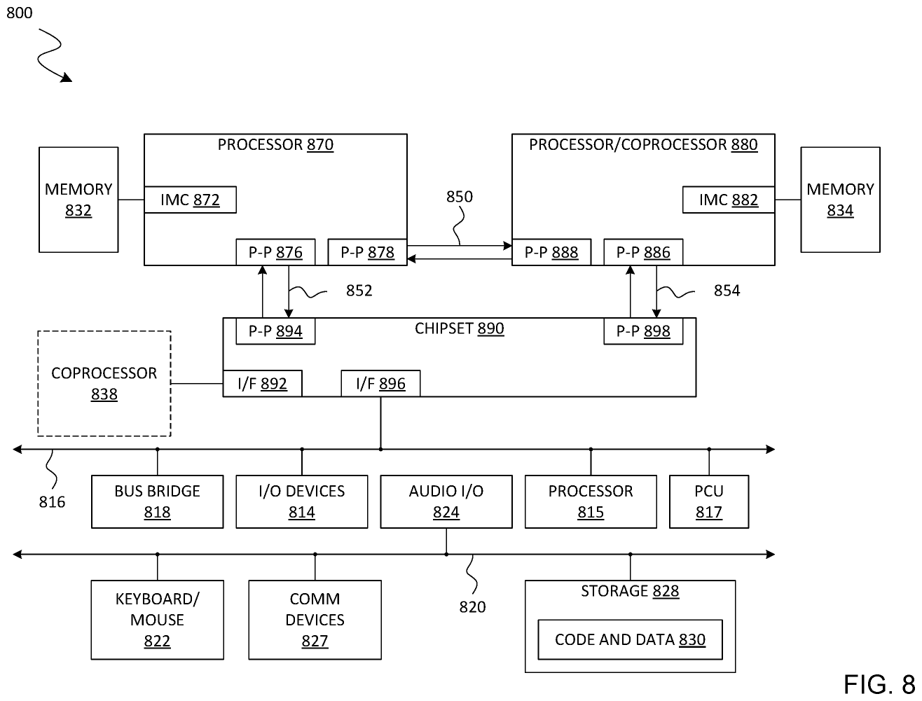

FIG. 8 illustrates an exemplary system. Multiprocessor system 800 is a point-to-point interconnect system and includes a plurality of processors including a first processor 870 and a second processor 880 coupled via a point-to-point interconnect 850. In some examples, the first processor 870 and the second processor 880 are homogeneous. In some examples, first processor 870 and the second processor 880 are heterogenous. Though the exemplary system 800 is shown to have two processors, the system may have three or more processors, or may be a single processor system.

Processors 870 and 880 are shown including integrated memory controller (IMC) circuitry 872 and 882, respectively. Processor 870 also includes as part of its interconnect controller point-to-point (P-P) interfaces 876 and 878; similarly, second processor 880 includes P-P interfaces 886 and 888. Processors 870, 880 may exchange information via the point-to-point (P-P) interconnect 850 using P-P interface circuits 878, 888. IMCs 872 and 882 couple the processors 870, 880 to respective memories, namely a memory 832 and a memory 834, which may be portions of main memory locally attached to the respective processors.

Processors 870, 880 may each exchange information with a chipset 890 via individual P-P interconnects 852, 854 using point to point interface circuits 876, 894, 886, 898. Chipset 890 may optionally exchange information with a coprocessor 838 via an interface 892. In some examples, the coprocessor 838 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 870, 880 or outside of both processors, yet connected with the processors via P-P interconnect, such that either or both processors' local cache information may be stored in the shared cache if a processor is placed into a low power mode.

Chipset 890 may be coupled to a first interconnect 816 via an interface 896. In some examples, first interconnect 816 may be a Peripheral Component Interconnect (PCI) interconnect, or an interconnect such as a PCI Express interconnect or another I/O interconnect. In some examples, one of the interconnects couples to a power control unit (PCU) 817, which may include circuitry, software, and/or firmware to perform power management operations with regard to the processors 870, 880 and/or co-processor 838. PCU 817 provides control information to a voltage regulator (not shown) to cause the voltage regulator to generate the appropriate regulated voltage. PCU 817 also provides control information to control the operating voltage generated. In various examples, PCU 817 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 817 is illustrated as being present as logic separate from the processor 870 and/or processor 880. In other cases, PCU 817 may execute on a given one or more of cores (not shown) of processor 870 or 880. In some cases, PCU 817 may be implemented as a microcontroller (dedicated or general-purpose) or other control logic configured to execute its own dedicated power management code, sometimes referred to as P-code. In yet other examples, power management operations to be performed by PCU 817 may be implemented externally to a processor, such as by way of a separate power management integrated circuit (PMIC) or another component external to the processor. In yet other examples, power management operations to be performed by PCU 817 may be implemented within BIOS or other system software.

Various I/O devices 814 may be coupled to first interconnect 816, along with a bus bridge 818 which couples first interconnect 816 to a second interconnect 820. In some examples, one or more additional processor(s) 815, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 816. In some examples, second interconnect 820 may be a low pin count (LPC) interconnect. Various devices may be coupled to second interconnect 820 including, for example, a keyboard and/or mouse 822, communication devices 827 and a storage circuitry 828. Storage circuitry 828 may be one or more non-transitory machine-readable storage media as described below, such as a disk drive or other mass storage device which may include instructions/code and data 830 in some examples. Further, an audio I/O 824 may be coupled to second interconnect 820. Note that other architectures than the point-to-point architecture described above are possible. For example, instead of the point-to-point architecture, a system such as multiprocessor system 800 may implement a multi-drop interconnect or other such architecture.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

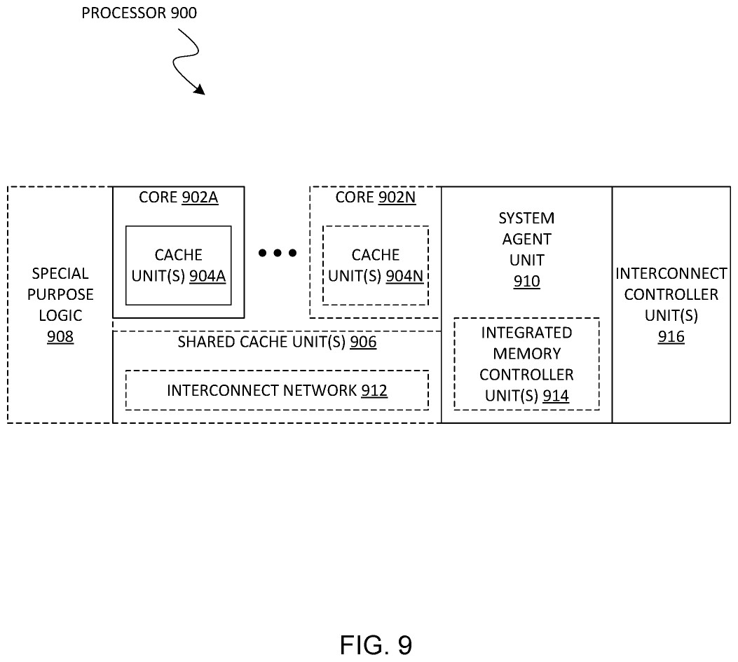

FIG. 9 illustrates a block diagram of an example processor 900 that may have more than one core and an integrated memory controller. The solid lined boxes illustrate a processor 900 with a single core 902A, a system agent unit circuitry 910, a set of one or more interconnect controller unit(s) circuitry 916, while the optional addition of the dashed lined boxes illustrates an alternative processor 900 with multiple cores 902A-N, a set of one or more integrated memory controller unit(s) circuitry 914 in the system agent unit circuitry 910, and special purpose logic 908, as well as a set of one or more interconnect controller units circuitry 916. Note that the processor 900 may be one of the processors 870 or 880, or co-processor 838 or 815 of FIG. 8.

Thus, different implementations of the processor 900 may include: 1) a CPU with the special purpose logic 908 being integrated graphics and/or scientific (throughput) logic (which may include one or more cores, not shown), and the cores 902A-N being one or more general purpose cores (e.g., general purpose in-order cores, general purpose out-of-order cores, or a combination of the two); 2) a coprocessor with the cores 902A-N being a large number of special purpose cores intended primarily for graphics and/or scientific (throughput); and 3) a coprocessor with the cores 902A-N being a large number of general purpose in-order cores. Thus, the processor 900 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 900 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 904A-N within the cores 902A-N, a set of one or more shared cache unit(s) circuitry 906, and external memory (not shown) coupled to the set of integrated memory controller unit(s) circuitry 914. The set of one or more shared cache unit(s) circuitry 906 may include one or more mid-level caches, such as level 2 (L2), level 3 (L3), level 4 (L4), or other levels of cache, such as a last level cache (LLC), and/or combinations thereof. While in some examples ring-based interconnect network circuitry 912 interconnects the special purpose logic 908 (e.g., integrated graphics logic), the set of shared cache unit(s) circuitry 906, and the system agent unit circuitry 910, alternative examples use any number of well-known techniques for interconnecting such units. In some examples, coherency is maintained between one or more of the shared cache unit(s) circuitry 906 and cores 902A-N.

In some examples, one or more of the cores 902A-N are capable of multi-threading. The system agent unit circuitry 910 includes those components coordinating and operating cores 902A-N. The system agent unit circuitry 910 may include, for example, power control unit (PCU) circuitry and/or display unit circuitry (not shown). The PCU may be or may include logic and components needed for regulating the power state of the cores 902A-N and/or the special purpose logic 908 (e.g., integrated graphics logic). The display unit circuitry is for driving one or more externally connected displays.

The cores 902A-N may be homogenous in terms of instruction set architecture (ISA). Alternatively, the cores 902A-N may be heterogeneous in terms of ISA; that is, a subset of the cores 902A-N may be capable of executing an ISA, while other cores may be capable of executing only a subset of that ISA or another ISA.

### Exemplary Core Architectures-in-Order and Out-of-Order Core Block Diagram

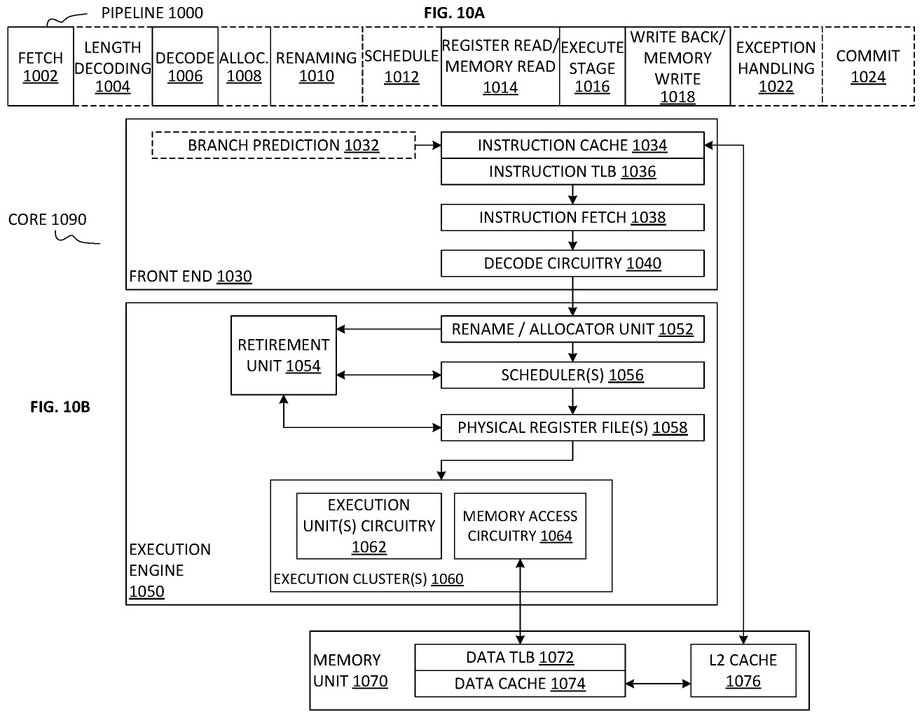

FIG. 10A is a block diagram illustrating both an exemplary in-order pipeline and an exemplary register renaming, out-of-order issue/execution pipeline according to examples. FIG. 10B is a block diagram illustrating both an exemplary example of an in-order architecture core and an exemplary register renaming, out-of-order issue/execution architecture core to be included in a processor according to examples. The solid lined boxes in FIGS. 10A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 10A, a processor pipeline 1000 includes a fetch stage 1002, an optional length decoding stage 1004, a decode stage 1006, an optional allocation (Alloc) stage 1008, an optional renaming stage 1010, a schedule (also known as a dispatch or issue) stage 1012, an optional register read/memory read stage 1014, an execute stage 1016, a write back/memory write stage 1018, an optional exception handling stage 1022, and an optional commit stage 1024. One or more operations can be performed in each of these processor pipeline stages. For example, during the fetch stage 1002, one or more instructions are fetched from instruction memory, and during the decode stage 1006, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1006 and the register read/memory read stage 1014 may be combined into one pipeline stage. In one example, during the execute stage 1016, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 10B may implement the pipeline 1000 as follows: 1) the instruction fetch circuitry 1038 performs the fetch and length decoding stages 1002 and 1004; 2) the decode circuitry 1040 performs the decode stage 1006; 3) the rename/allocator unit circuitry 1052 performs the allocation stage 1008 and renaming stage 1010; 4) the scheduler(s) circuitry 1056 performs the schedule stage 1012; 5) the physical register file(s) circuitry 1058 and the memory unit circuitry 1070 perform the register read/memory read stage 1014; the execution cluster(s) 1060 perform the execute stage 1016; 6) the memory unit circuitry 1070 and the physical register file(s) circuitry 1058 perform the write back/memory write stage 1018; 7) various circuitry may be involved in the exception handling stage 1022; and 8) the retirement unit circuitry 1054 and the physical register file(s) circuitry 1058 perform the commit stage 1024.

FIG. 10B shows a processor core 1090 including front-end unit circuitry 1030 coupled to an execution engine unit circuitry 1050, and both are coupled to a memory unit circuitry 1070. The core 1090 may be a reduced instruction set architecture computing (RISC) core, a complex instruction set architecture computing (CISC) core, a very long instruction word (VLIW) core, or a hybrid or alternative core type. As yet another option, the core 1090 may be a special-purpose core, such as, for example, a network or communication core, compression engine, coprocessor core, general purpose computing graphics processing unit (GPGPU) core, graphics core, or the like.

The front end unit circuitry 1030 may include branch prediction circuitry 1032 coupled to an instruction cache circuitry 1034, which is coupled to an instruction translation lookaside buffer (TLB) 1036, which is coupled to instruction fetch circuitry 1038, which is coupled to decode circuitry 1040. In one example, the instruction cache circuitry 1034 is included in the memory unit circuitry 1070 rather than the front-end circuitry 1030. The decode circuitry 1040 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 1040 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1040 may be implemented using various different mechanisms. Examples of suitable mechanisms include, but are not limited to, look-up tables, hardware implementations, programmable logic arrays (PLAs), microcode read only memories (ROMs), etc. In one example, the core 1090 includes a microcode ROM (not shown) or other medium that stores microcode for certain macroinstructions (e.g., in decode circuitry 1040 or otherwise within the front end circuitry 1030). In one example, the decode circuitry 1040 includes a micro-operation (micro-op) or operation cache (not shown) to hold/cache decoded operations, micro-tags, or micro-operations generated during the decode or other stages of the processor pipeline 1000. The decode circuitry 1040 may be coupled to rename/allocator unit circuitry 1052 in the execution engine circuitry 1050.

The execution engine circuitry 1050 includes the rename/allocator unit circuitry 1052 coupled to a retirement unit circuitry 1054 and a set of one or more scheduler(s) circuitry 1056. The scheduler(s) circuitry 1056 represents any number of different schedulers, including reservations stations, central instruction window, etc. In some examples, the scheduler(s) circuitry 1056 can include arithmetic logic unit (ALU) scheduler/scheduling circuitry, ALU queues, arithmetic generation unit (AGU) scheduler/scheduling circuitry, AGU queues, etc. The scheduler(s) circuitry 1056 is coupled to the physical register file(s) circuitry 1058. Each of the physical register file(s) circuitry 1058 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1058 includes vector registers unit circuitry, writemask registers unit circuitry, and scalar register unit circuitry. These register units may provide architectural vector registers, vector mask registers, general-purpose registers, etc. The physical register file(s) circuitry 1058 is coupled to the retirement unit circuitry 1054 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1054 and the physical register file(s) circuitry 1058 are coupled to the execution cluster(s) 1060. The execution cluster(s) 1060 includes a set of one or more execution unit(s) circuitry 1062 and a set of one or more memory access circuitry 1064. The execution unit(s) circuitry 1062 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 1056, physical register file(s) circuitry 1058, and execution cluster(s) 1060 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 1064). It should also be understood that where separate pipelines are used, one or more of these pipelines may be out-of-order issue/execution and the rest in-order.

In some examples, the execution engine unit circuitry 1050 may perform load store unit (LSU) address/data pipelining to an Advanced Microcontroller Bus (AMB) interface (not shown), and address phase and writeback, data phase load, store, and branches.

The set of memory access circuitry 1064 is coupled to the memory unit circuitry 1070, which includes data TLB circuitry 1072 coupled to a data cache circuitry 1074 coupled to a level 2 (L2) cache circuitry 1076. In one exemplary example, the memory access circuitry 1064 may include a load unit circuitry, a store address unit circuit, and a store data unit circuitry, each of which is coupled to the data TLB circuitry 1072 in the memory unit circuitry 1070. The instruction cache circuitry 1034 is further coupled to the level 2 (L2) cache circuitry 1076 in the memory unit circuitry 1070. In one example, the instruction cache 1034 and the data cache 1074 are combined into a single instruction and data cache (not shown) in L2 cache circuitry 1076, a level 3 (L3) cache circuitry (not shown), and/or main memory. The L2 cache circuitry 1076 is coupled to one or more other levels of cache and eventually to a main memory.

The core 1090 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1090 includes logic to support a packed data instruction set architecture extension (e.g., AVX1, AVX2), thereby allowing the operations used by many multimedia applications to be performed using packed data.

### Exemplary Execution Unit(s) Circuitry

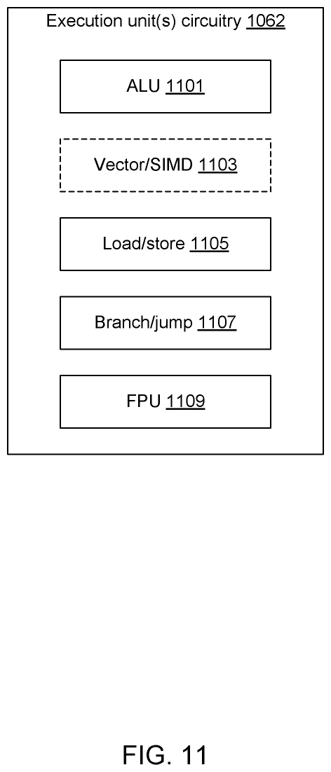

FIG. 11 illustrates examples of execution unit(s) circuitry, such as execution unit(s) circuitry 1062 of FIG. 10B. As illustrated, execution unit(s) circuity 1062 may include one or more ALU circuits 1101, optional vector/single instruction multiple data (SIMD) circuits 1103, load/store circuits 1105, branch/jump circuits 1107, and/or Floating-point unit (FPU) circuits 1109. ALU circuits 1101 perform integer arithmetic and/or Boolean operations. Vector/SIMD circuits 1103 perform vector/SIMD operations on packed data (such as SIMD/vector registers). Load/store circuits 1105 execute load and store instructions to load data from memory into registers or store from registers to memory. Load/store circuits 1105 may also generate addresses. Branch/jump circuits 1107 cause a branch or jump to a memory address depending on the instruction. FPU circuits 1109 perform floating-point arithmetic. The width of the execution unit(s) circuitry 1062 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

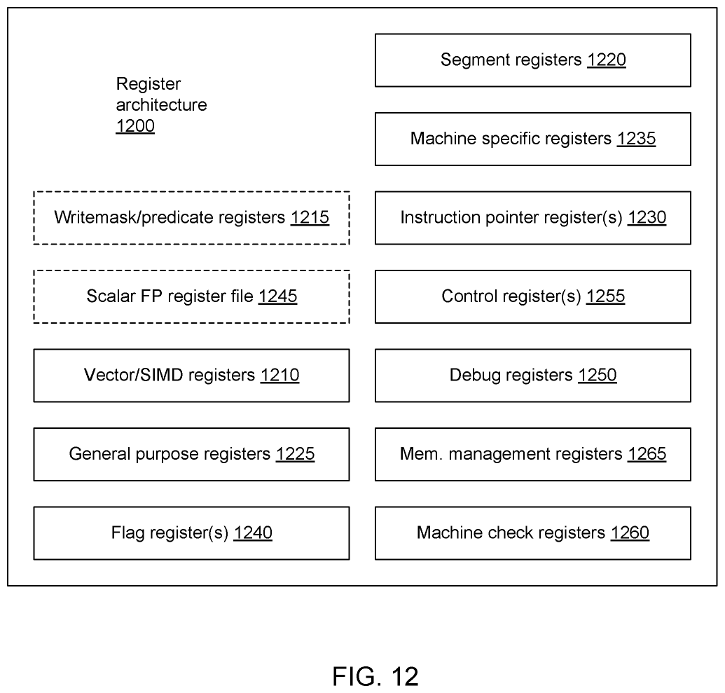

FIG. 12 is a block diagram of a register architecture 1200 according to some examples. As illustrated, the register architecture 1200 includes vector/SIMD registers 1210 that vary from 128-bit to 1,024 bits width. In some examples, the vector/SIMD registers 1210 are physically 512-bits and, depending upon the mapping, only some of the lower bits are used. For example, in some examples, the vector/SIMD registers 1210 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1200 includes writemask/predicate registers 1215. For example, in some examples, there are 8 writemask/predicate registers (sometimes called k0 through k7) that are each 16-bit, 32-bit, 64-bit, or 128-bit in size. Writemask/predicate registers 1215 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1215 corresponds to a data element position of the destination. In other examples, the writemask/predicate registers 1215 are scalable and consists of a set number of enable bits for a given vector element (e.g., 8 enable bits per 64-bit vector element).

The register architecture 1200 includes a plurality of general-purpose registers 1225. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1200 includes scalar floating-point (FP) register 1245 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1240 (e.g., EFLAGS, RFLAGS, etc.) store status and control information for arithmetic, compare, and system operations. For example, the one or more flag registers 1240 may store condition code information such as carry, parity, auxiliary carry, zero, sign, and overflow. In some examples, the one or more flag registers 1240 are called program status and control registers.

Segment registers 1220 contain segment points for use in accessing memory. In some examples, these registers are referenced by the names CS, DS, SS, ES, FS, and GS.

Machine specific registers (MSRs) 1235 control and report on processor performance. Most MSRs 1235 handle system-related functions and are not accessible to an application program. Machine check registers 1260 consist of control, status, and error reporting MSRs that are used to detect and report on hardware errors.

One or more instruction pointer register(s) 1230 store an instruction pointer value. Control register(s) 1255 (e.g., CR0-CR4) determine the operating mode of a processor (e.g., processor 870, 880, 838, 815, and/or 900) and the characteristics of a currently executing task. Debug registers 1250 control and allow for the monitoring of a processor or core's debugging operations.

Memory (mem) management registers 1265 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1200 may, for example, be used in physical register file(s) circuitry 1058.

Numerous details are described herein to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Techniques and architectures for determining access to networked resources are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

In one or more first embodiments, an integrated circuit (IC) comprises first circuitry to receive a first message which is communicated, via a credit management bus (CMB), to a target agent from a first initiator agent of initiator agents which are each coupled to the target agent via both the CMB and a switched network, the first circuitry further to determine, based on the first message, that the first initiator agent has detected an instance of one of a credit surplus condition or a credit scarcity condition, second circuitry to identify a current distribution of a first plurality of credits among the initiator agents, third circuitry coupled to the first circuitry and the second circuitry, the third circuitry to perform, based on the current distribution and the instance, an identification of a next distribution of a second plurality of credits among the initiator agents, and fourth circuitry coupled to the third circuitry, the fourth circuitry to send a second message via the CMB based on the identification, wherein the second message is to change an allocation of one or more credits to at least one of the initiation agents, wherein, with the second plurality of credits, the initiator agents are to access a shared resource of the target agent via the switched network.

In one or more second embodiments, further to the first embodiment, the first message is a credit release message which identifies a total number of credits to be deallocated from the first initiation agent.

In one or more third embodiments, further to the second embodiment, the fourth circuitry, based on the credit release message, is to prevent a return of one or more other credits to the first initiator agent, wherein the one or more other credits are each to be communicated from the first initiator agent, via the CMB, to the target agent.

In one or more fourth embodiments, further to the first embodiment or the second embodiment, the first message is a credit request message which identifies a total number of credits to be allocated to the first initiation agent.

In one or more fifth embodiments, further to the first embodiment or the second embodiment, the shared resource is a buffer to receive each of a first plurality of messages from the initiator agents, the first plurality of messages to be communicated to the target agent via the switched network.

In one or more sixth embodiments, further to the fifth embodiment, the buffer comprises a first partition which is shared by all of the initiator agents, wherein the first partition is to receive the first plurality of messages, and a second partition to which access by one of the initiator agents is at least temporarily restricted, wherein the second partition is to receive messages of a first virtual channel.

In one or more seventh embodiments, further to the first embodiment or the second embodiment, a network on chip comprises the target agent, the initiator agents, the switched network, and the CMB, and the target agent comprises the IC.

In one or more eighth embodiments, further to the seventh embodiment, the target agent further comprises a pool of credits which are currently unallocated, and based on the identification, the fourth circuitry is to allocate one or more credits which are drawn from the pool of credits.

In one or more ninth embodiments, further to the first embodiment or the second embodiment, the third circuitry to perform the identification of the next distribution comprises the third circuitry to determine whether a baseline credit distribution is sufficient to resolve one of one or more credit deficit conditions, or one or more credit surplus conditions.

In one or more tenth embodiments, a method comprises receiving at a target agent a first message which is communicated, via a credit management bus (CMB), from a first initiator agent of initiator agents which are each coupled to the target agent via both the CMB and a switched network, and with the target agent determining, based on the first message, that the first initiator agent has detected an instance of one of a credit surplus condition or a credit scarcity condition, identifying a current distribution of a first plurality of credits among the initiator agents, based on the current distribution and the instance, performing an identification of a next distribution of a second plurality of credits among the initiator agents, and sending a second message via the CMB based on the identification of the next distribution, wherein the second message is to change an allocation of one or more credits to at least one of the initiation agents, wherein, with the second plurality of credits, the initiator agents are to access a shared resource of the target agent via the switched network.

In one or more eleventh embodiments, further to the tenth embodiment, the first message is a credit release message which identifies a total number of credits to be deallocated from the first initiation agent.

In one or more twelfth embodiments, further to the eleventh embodiment, based on the credit release message, a return of one or more other credits to the first initiator agent is prevented, wherein the one or more other credits are each communicated from the first initiator agent, via the CMB, to the target agent.

In one or more thirteenth embodiments, further to the tenth embodiment or the eleventh embodiment, the first message is a credit request message which identifies a total number of credits to be allocated to the first initiation agent.

In one or more fourteenth embodiments, further to the tenth embodiment or the eleventh embodiment, the shared resource is a buffer which receives each of a first plurality of messages from the initiator agents, the first plurality of messages communicated to the target agent via the switched network.

In one or more fifteenth embodiments, further to the fourteenth embodiment, the buffer comprises a first partition which is shared by all of the initiator agents, wherein the first partition receives the first plurality of messages, and a second partition to which access by one of the initiator agents is at least temporarily restricted, wherein the second partition receives messages of a first virtual channel.

In one or more sixteenth embodiments, further to the tenth embodiment or the eleventh embodiment, a network on chip comprises the target agent, the initiator agents, the switched network, and the CMB, and the target agent comprises the IC.

In one or more seventeenth embodiments, further to the sixteenth embodiment, the target agent further comprises a pool of credits which are currently unallocated, and based on the identification, one or more credits from the pool of credits are allocated each to a respective one of the initiator agents.

In one or more eighteenth embodiments, further to the tenth embodiment or the eleventh embodiment, performing the identification of the next distribution comprises determining whether a baseline credit distribution is sufficient to resolve one of one or more credit deficit conditions, or one or more credit surplus conditions.

In one or more nineteenth embodiments, further to the tenth embodiment or the eleventh embodiment, method further comprises, at the first initiator agent performing an evaluation of a utilization of one or more allocated credits by the first initiation agent, detecting the instance based on the evaluation of the utilization, and sending the first message, via the CMB, to the target agent.

In one or more twentieth embodiments, a system comprises a switched network, a credit management bus (CMB), initiator agents comprising a first initiator agent, and a target agent coupled to each of the initiator agents both via the switched network and via the CMB, the target agent comprising first circuitry to receive a first message which is communicated from the first initiator agent to the target agent via the CMB, the first circuitry further to determine, based on the first message, that the first initiator agent has detected an instance of one of a credit surplus condition or a credit scarcity condition, second circuitry to identify a current distribution of a first plurality of credits among the initiator agents, third circuitry coupled to the first circuitry and the second circuitry, the third circuitry to perform, based on the current distribution and the instance, an identification of a next distribution of a second plurality of credits among the initiator agents, and fourth circuitry coupled to the third circuitry, the fourth circuitry to send a second message via the CMB based on the identification of the next distribution, wherein the second message is to change an allocation of one or more credits to at least one of the initiation agents, wherein, with the second plurality of credits, the initiator agents are to access a shared resource of the target agent via the switched network.

In one or more twenty-first embodiments, further to the twentieth embodiment, the first message is a credit release message which identifies a total number of credits to be deallocated from the first initiation agent.

In one or more twenty-second embodiments, further to the twenty-first embodiment, based on the credit release message, the fourth circuitry is to prevent a return of one or more other credits to the first initiator agent, wherein the one or more other credits are each to be communicated from the first initiator agent, via the CMB, to the target agent.

In one or more twenty-third embodiments, further to the twentieth embodiment or the twenty-first embodiment, the first message is a credit request message which identifies a total number of credits to be allocated to the first initiation agent.

In one or more twenty-fourth embodiments, further to the twentieth embodiment or the twenty-first embodiment, the shared resource is a buffer to receive each of a first plurality of messages from the initiator agents, the first plurality of messages to be communicated to the target agent via the switched network.

In one or more twenty-fifth embodiments, further to the twenty-fourth embodiment, the buffer comprises a first partition which is shared by all of the initiator agents, wherein the first partition is to receive the first plurality of messages, and a second partition to which access by one of the initiator agents is at least temporarily restricted, wherein the second partition is to receive messages of a first virtual channel.

In one or more twenty-sixth embodiments, further to the twentieth embodiment or the twenty-first embodiment, a network on chip comprises the target agent, the initiator agents, the switched network, and the CMB, and the target agent comprises the IC.

In one or more twenty-seventh embodiments, further to the twenty-sixth embodiment, the target agent further comprises a pool of credits which are currently unallocated, and based on the identification, the fourth circuitry is to allocate one or more credits which are drawn from the pool of credits.

In one or more twenty-eighth embodiments, further to the twentieth embodiment or the twenty-first embodiment, the third circuitry to perform the identification of the next distribution comprises the third circuitry to determine whether a baseline credit distribution is sufficient to resolve one of one or more credit deficit conditions, or one or more credit surplus conditions.

In one or more twenty-ninth embodiments, further to the twentieth embodiment or the twenty-first embodiment, the first initiator agent comprises circuitry to perform an evaluation of a utilization of one or more allocated credits by the first initiation agent, detect the instance based on the evaluation of the utilization, and send the first message, via the CMB, to the target agent.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. An integrated circuit (IC) comprising:
first circuitry to receive a first message which is communicated, via a credit management bus (CMB), to a target agent from a first initiator agent of initiator agents which are each coupled to the target agent via both the CMB and a switched network, the first circuitry further to determine, based on the first message, that the first initiator agent has detected an instance of one of a credit surplus condition or a credit scarcity condition;
second circuitry to identify a current distribution of a first plurality of credits among the initiator agents;
third circuitry coupled to the first circuitry and the second circuitry, the third circuitry to perform, based on the current distribution and the instance, an identification of a next distribution of a second plurality of credits among the initiator agents; and
fourth circuitry coupled to the third circuitry, the fourth circuitry to send a second message via the CMB based on the identification, wherein the second message is to change an allocation of one or more credits to at least one of the initiation agents;
wherein, with the second plurality of credits, the initiator agents are to access a shared resource of the target agent via the switched network.

2. The IC of claim 1, wherein the first message is a credit release message which identifies a total number of credits to be deallocated from the first initiation agent.

3. The IC of claim 2, wherein, based on the credit release message, the fourth circuitry is to prevent a return of one or more other credits back to the first initiator agent, wherein the one or more other credits are each to be communicated from the first initiator agent, via the CMB, to the target agent.

4. The IC of claim 1, wherein the first message is a credit request message which identifies a total number of credits to be allocated to the first initiation agent.

5. The IC of claim 1, wherein the shared resource is a buffer to receive each of a first plurality of messages from the initiator agents, the first plurality of messages to be communicated to the target agent via the switched network.

6. The IC of claim 5, wherein the buffer comprises:
a first partition which is shared by all of the initiator agents, wherein the first partition is to receive the first plurality of messages; and
a second partition to which access by one of the initiator agents is at least temporarily restricted, wherein the second partition is to receive messages of a first virtual channel.

7. The IC of claim 1, wherein:
a network on chip comprises the target agent, the initiator agents, the switched network, and the CMB; and
the target agent comprises the IC.

8. The IC of claim 7, wherein:
the target agent further comprises a pool of credits which are currently unallocated; and
based on the identification, the fourth circuitry is to allocate one or more credits which are drawn from the pool of credits.

9. The IC of claim 1, wherein the third circuitry to perform the identification of the next distribution comprises the third circuitry to determine whether a baseline credit distribution is sufficient to resolve one of:
one or more credit deficit conditions; or
one or more credit surplus conditions.

10. A method comprising:
receiving at a target agent a first message which is communicated, via a credit management bus (CMB), from a first initiator agent of initiator agents which are each coupled to the target agent via both the CMB and a switched network; and
with the target agent:
determining, based on the first message, that the first initiator agent has detected an instance of one of a credit surplus condition or a credit scarcity condition;
identifying a current distribution of a first plurality of credits among the initiator agents;
based on the current distribution and the instance, performing an identification of a next distribution of a second plurality of credits among the initiator agents; and
sending a second message via the CMB based on the identification of the next distribution, wherein the second message is to change an allocation of one or more credits to at least one of the initiation agents;
wherein, with the second plurality of credits, the initiator agents are to access a shared resource of the target agent via the switched network.

11. The method of claim 10, wherein the first message is a credit release message which identifies a total number of credits to be deallocated from the first initiation agent.

12. The method of claim 10, wherein the first message is a credit request message which identifies a total number of credits to be allocated to the first initiation agent.

13. The method of claim 10, wherein the shared resource is a buffer which receives each of a first plurality of messages from the initiator agents, the first plurality of messages communicated to the target agent via the switched network.

14. The method of claim 10, wherein performing the identification of the next distribution comprises determining whether a baseline credit distribution is sufficient to resolve one of:
one or more credit deficit conditions; or
one or more credit surplus conditions.

15. A system comprising:
a switched network;
a credit management bus (CMB);
initiator agents comprising a first initiator agent; and
a target agent coupled to each of the initiator agents both via the switched network and via the CMB, the target agent comprising:
first circuitry to receive a first message which is communicated from the first initiator agent to the target agent via the CMB, the first circuitry further to determine, based on the first message, that the first initiator agent has detected an instance of one of a credit surplus condition or a credit scarcity condition;
second circuitry to identify a current distribution of a first plurality of credits among the initiator agents;
third circuitry coupled to the first circuitry and the second circuitry, the third circuitry to perform, based on the current distribution and the instance, an identification of a next distribution of a second plurality of credits among the initiator agents; and
fourth circuitry coupled to the third circuitry, the fourth circuitry to send a second message via the CMB based on the identification of the next distribution, wherein the second message is to change an allocation of one or more credits to at least one of the initiation agents;
wherein, with the second plurality of credits, the initiator agents are to access a shared resource of the target agent via the switched network.

16. The system of claim 15, wherein the first message is a credit release message which identifies a total number of credits to be deallocated from the first initiation agent.

17. The system of claim 15, wherein the first message is a credit request message which identifies a total number of credits to be allocated to the first initiation agent.

18. The system of claim 15, wherein the shared resource is a buffer to receive each of a first plurality of messages from the initiator agents, the first plurality of messages to be communicated to the target agent via the switched network.

19. The system of claim 15, wherein the third circuitry to perform the identification of the next distribution comprises the third circuitry to determine whether a baseline credit distribution is sufficient to resolve one of:
one or more credit deficit conditions; or
one or more credit surplus conditions.

20. The system of claim 15, wherein the first initiator agent comprises circuitry to:
perform an evaluation of a utilization of one or more allocated credits by the first initiation agent;
detect the instance based on the evaluation of the utilization; and
send the first message, via the CMB, to the target agent.
